(19) United States
(12) Patent Application Publication
(10) Pub. No.: US 2006/0192166 A1
(43) Pub. Date: Aug. 31, 2006

(54) Upper valve part

(75) Inventors: Lutz Lange, Ludenscheid (DE); Jorg Wilhelm Wolfgang Wendt, Ludenscheid (DE)

Correspondence Address: WILLIAM COLLARD;COLLARD & ROE, P.C., 1077 NORTHERN BOULEVARD, ROSLYN, NY, 11576, US

(73) Assignee: Fluhs Drehtechnick GmbH

(21) Appl. No.: 11/364,899

(22) Filed: Feb. 27, 2006

(30) Foreign Application Priority Data
Feb. 26, 2005 (DE) 20 2005 003 127.5

(51) Int. Cl. F16K 31/44

(52) U.S. Cl. 251/264

(57) ABSTRACT

An upper valve part having a head piece through which a spindle passes in the center, by way of which spindle a valve can be activated. The valve comes to rest against the valve seat of a housing. The head piece has a connection thread for the housing and a sealing surface on a side facing away from the housing and adjacent the connection thread. The surface forms a part of an O-ring installation space when a cap is screwed onto the head piece.

### BACKGROUND OF THE INVENTION

1. Field of the Invention

The invention relates to an upper valve part having a head piece through which a spindle passes in the center, by way of which spindle a valve can be activated, which valve comes to rest against the valve seat of a housing, and having a connection thread for the housing, which thread is disposed on the head piece.

2. The Prior Art

The exit of media from fittings is controlled using upper valve parts. For this purpose, the upper valve part is screwed into the housing of a fitting by its head piece and a turning handle or lever is set onto its spindle. In the case of known upper valve parts (see German Patent Nos. DE 32 07 895 C2, DE 36 38 180 C2, DE 87 15 044 U1), two disks for controlling the through-flow are provided, in each instance. The disks are produced from ceramic material. One of the two disks, the control disk, is disposed to rotate in the upper valve part, using a driver that is connected with the spindle. The other disk, the inlet disk, is a fixed valve seat disk, also referred to as a fixed disk. When the control disk is rotated, the disks slide on one another. On the side facing the valve seat of the fitting, a seal ring is disposed, which rests against the inlet disk. The seal ring projects beyond the face of the upper valve part. It serves for a seal both towards the inlet disk and towards the valve seat of the fitting.

A seal ring is provided to seal the upper valve part relative to the housing of the fitting. The seal ring comes to lie against an O-ring sealing surface that is provided in the housing. Generally, the upper valve part is supplied with an O-ring already installed in it. When the upper valve part is installed in the housing, the upper valve part is screwed into the housing. For this purpose, the upper valve part has a connection thread that corresponds to a thread in the housing. For correct placement of the seal ring, which is configured as an O-ring, in the sealing surface of the upper valve part, the O-ring must pass by the connection thread for its positioning in the ring groove on the upper valve part. In this connection, damage to the O-ring can occur, making a perfect seal difficult. For this reason, flat seals are frequently used, in addition, in the region where the head piece contacts the housing in order to allow a reliable seal. However, this increases the effort and expenditure in connection with assembly. Furthermore, the flat seal is visible between the head piece and housing. Furthermore, there is the risk that the flat seal will project towards the inside, beyond the insertion bore for the upper valve part, thereby making it more difficult to screw the upper valve part in, for one thing. Finally, the flat seal can also be damaged by the connection thread.

### SUMMARY OF THE INVENTION

It is therefore an object of the invention to create an upper valve part that can be screwed into the housing without damage to the O-ring, and thereby allows a perfect seal with regard to the housing, without the additional need for a flat seal. According to the invention, this task is accomplished in that the head piece has a sealing surface toward the side facing away from the housing, following the connection thread, which surface forms a part of an O-ring installation space when a cap is screwed onto the head piece.

Because a sealing surface is present on the side of the connection thread that faces away from the housing, there is the possibility of bringing the O-ring into its position intended by the design by screwing on a cap, without damaging it. The O-ring is merely pushed into the position on the sealing surface.

Therefore, an upper valve part that can be screwed into the housing without damage to the O-ring, and thereby allows a perfect seal with regard to the housing, without the additional need for a flat seal, is created with the invention. Also, hindrance of the screwing-in process by the O-ring is avoided.

In a further development of the invention, the O-ring installation space is formed by the contour of the O-ring sealing surface on the housing, the sealing surface as well as the ring surface of the cap. A reliable seal of the upper valve part relative to the housing is made possible using the O-ring, by means of the configuration of the O-ring installation space.

In a further development of the invention, the thread combination between head piece and cap has a lesser pitch than the thread combination between connection thread and housing. Because of this configuration, a rotation of the cap in the direction of the housing results in wedging of the head piece in the housing, thereby preventing rotation of the head piece into the housing, to a great extent. In this way, it is possible to align the handle precisely, relative to the housing, since the position of the head piece can be wedged into the housing by means of screwing the cap in the direction of the housing. In this connection, the upper valve part can be used in known housings without any change.

In an embodiment of the invention, a stuffing box is provided, which surrounds the spindle and is positioned in a recess in the head piece. The stuffing box meters the rotational movement between spindle and head piece and thereby allows a variation of the haptics during rotation of the spindle.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows in an enlarged representation, an upper valve part, in the state of being screwed into a housing, partially in a side view, partially in axial cross-section;

FIG. 2 shows a bottom view of a control disk;

FIG. 3 shows a representation of a control disk, partially in a side view, partially in axial cross-section;

FIG. 4 shows a top view of the control disk shown in FIG. 3; and

FIG. 5 shows the upper valve part shown in FIG. 1, with a cap partially screwed on.

### DETAILED DESCRIPTION OF THE PREFERRED EMBODIMENT

Referring now in detail to the drawings, the upper valve part selected as an exemplary embodiment has a head piece 1, through the center of which a spindle 2, guided radially in it, passes. A valve that rests on a housing 6 with the valve seat 61 can be activated via spindle 2. The valve is formed by a control disk 3 and an inlet disk 4. Control disk 3 is connected with spindle 2 with a positive lock, and guided radially in head piece 1. On the side of control disk 3 that faces away from the spindle 2, inlet disk 4 is provided in head piece 1, followed by a sealing ring 5, which comes to rest on valve seat 61 of housing 6. A cap 7 can be screwed onto the outside of head piece 1. On its end facing away from housing 6, spindle 2 is surrounded by a stuffing box 8.

Head piece 1 consists of a symmetrical hollow body, the two faces of which are open. On the side facing housing 6, head piece 1 has a sleeve-like part 10. Passage windows 11 are provided in part 10, which are delimited by longitudinal crosspieces 12. In the exemplary embodiment, two windows 11 delimited by two crosspieces 12 are provided. A relieved region 101 is disposed in sleeve-like part 10, on the inside, in the region of the end facing valve seat 61. Following this, two recesses that lie diametrically opposite one another are provided (not shown).

Following the windows 11, head piece 1 is provided, on the outside, with a connection thread 13. Using connection thread 13, the head piece can be screwed into housing 6 of the fitting. Adjacent to the connection thread 13, a sealing surface 14 is formed on head piece 1, on which surface an O-ring 91 rests. Sealing surface 14 is configured to be smooth and without any thread. Sealing surface 14 is followed, offset towards the inside, by an outside thread 15, which makes a transition into a narrowed region 16 that ends in a cylinder surface 17. Head piece 1 therefore has a shape that narrows in the direction of the side facing away from housing 6. On its end facing away from housing 6, head piece 1 is provided with a recess 18 on the inside, which ends in a step 19 directed towards the inside.

Spindle 2 is essentially structured to be solid. At its face that faces away from the water inflow, it is configured as an outer polygon 21 on the outside and provided with a dead-end hole 22 with an inside thread for attaching a turning handle, not shown, on the inside. Following that, a cylinder surface 23 is provided on the outside of the spindle, with which spindle 2 is guided radially in head piece 1. Two ring grooves 24 and 25 are provided in cylinder surface 23, of which ring groove 25 accommodates an O-ring 93. O-ring 93 seals spindle 2 off from head piece 1. A recess 26 is provided between the cylinder surface 23 and the outer polygon 21.

Spindle 2 can rotate in head piece 1, within limits. On the side opposite the outer polygon 21, a crosspiece 27 is molded onto the spindle, on the outside, for this purpose. Crosspiece 27 can rotate between a stop provided on the inside of head piece 1. A disk 28 follows crosspiece 27, which disk has a driver 29 on its side facing housing 6.

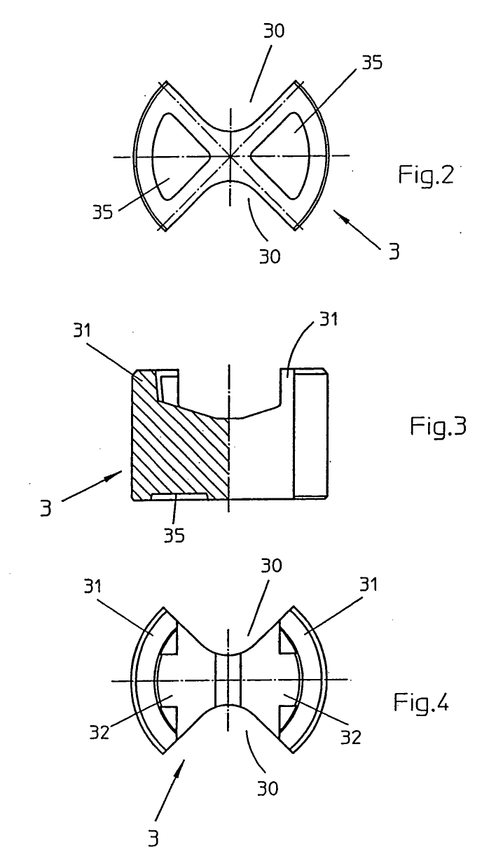

Control disk 3 has an essentially barrel-shaped configuration, from which two arc segments 30 that lie opposite one another have been taken out (FIGS. 2 and 4). Arc segments 30 have an angle of approximately 90 in this embodiment. On its side facing spindle 2, control disk 3 has a ring-shaped joined-on piece 31. Ring-shaped joined-on piece 31 surrounds driver 29 of spindle 2 in the assembled state. At the foot of joined-on piece 31, recesses 32 are formed, into which driver 29 engages. On the face facing away from spindle 2, two sector-shaped depressions 35 that lie opposite one another are provided in control disk 3.

Inlet disk 4 has two noses (not shown) that lie diametrically opposite one another, on its circumference. With the noses, disk 4 engages into the recesses that are provided in sleeve-shaped part 10 of head piece 1. Inlet disk 4 is thereby disposed in head piece 1 so that it cannot rotate. Disk 4 has sector-shaped passage openings. In this embodiment, two passage openings that lie diametrically opposite one another are provided.

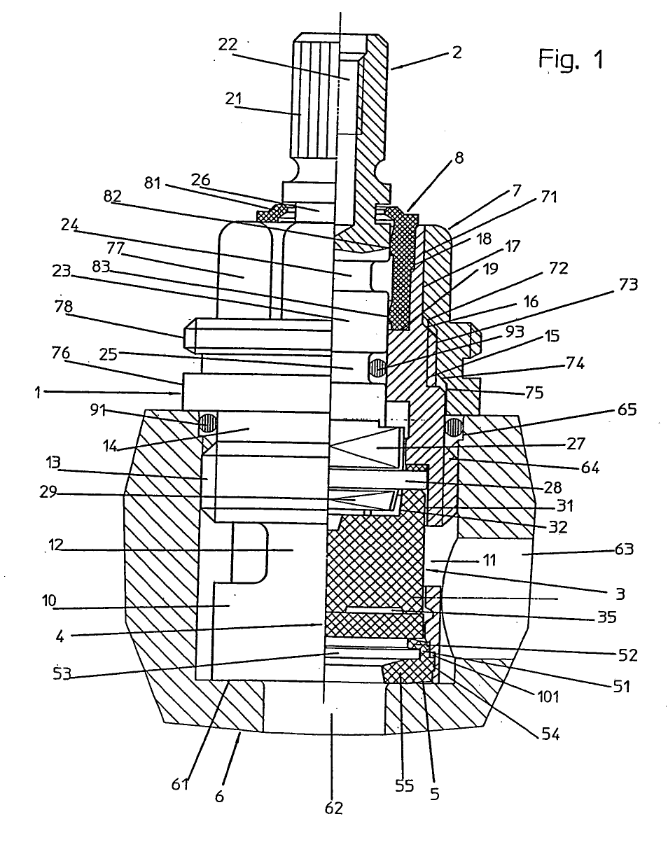

Seal ring 5 is configured in the manner of a lip seal. It consists essentially of a center piece 51, on which a lip 52 is formed on its face that faces disk 4. Lip 52 has an essentially trapezoid configuration in cross-section. Lip 52 is disposed at an angle to the horizontal. The outer surface of lip 52 lies against the disk 4, forming a seal (FIG. 1). Following lip 52, a recess 53 is formed between the latter and center piece 51. Center piece 51 is provided with a collar 54 on the outside, which engages into relieved region 101 of sleeve-like part 10. On the inside, a bead 55 is formed on center piece 51. In the assembled state of the upper valve part, the outside of bead 55 lies flat on valve seat 61.

Housing 6 is provided with a valve seat 61. An inflow 62, through which water enters into the upper valve part, ends in valve seat 61. In the region of the passage windows 11, there is an outflow channel 63, through which the water exits from the upper valve part. Following outflow channel 63, housing 6 has a connection thread 64, followed by an O-ring sealing surface 65. O-ring sealing surface 65 accommodates O-ring 91 in the assembled state of the upper valve part in the housing.

Cap 7 is configured essentially as a hollow cylinder. It has a cylinder surface 71 on the inside, at its end facing away from housing 6, which makes a transition into a widened region 72. Widened region 72 is followed by an inside thread 73, which corresponds to outside thread 15 of head piece 1. Inside thread 73 ends in a second widened region 74, followed by a cylinder surface 75. On the outside, in the region of cylinder surface 75, a screw-in collar 76 is formed, which lies on the housing 6 with a ring surface 79 after the upper valve part has been screwed in, and stands in contact with the seal ring 91. Screwing the head piece into housing 6 takes place by means of an outer polygon 77 that is provided on the side of cap 7 that faces away from housing 6. On outside, cap 7 is provided with an outside thread 78 for accommodating a sleeve, not shown. However, cap 7 can also be configured towards the outside, overall, in the manner of a truncated cone that has recesses in the manner of a polygon in the region of the screw-in collar.

Stuffing box 8 is made of plastic. It serves to brake the movement between spindle 2 as well as head piece 1 and has a rotation-symmetrical shape. At its one end, it is provided with a collar 81 that engages into recess 26 of the spindle, in the assembled state. On the inside, stuffing box 8 is provided with two beads 82 and 83, which are spaced apart from one another, and stand in contact with spindle 2 on both sides of the ring groove 24. In the assembled state, stuffing box 8 is positioned in the recess 18 of head piece 1. Stuffing box 8 then rests against step 19 with its end facing away from collar 81.

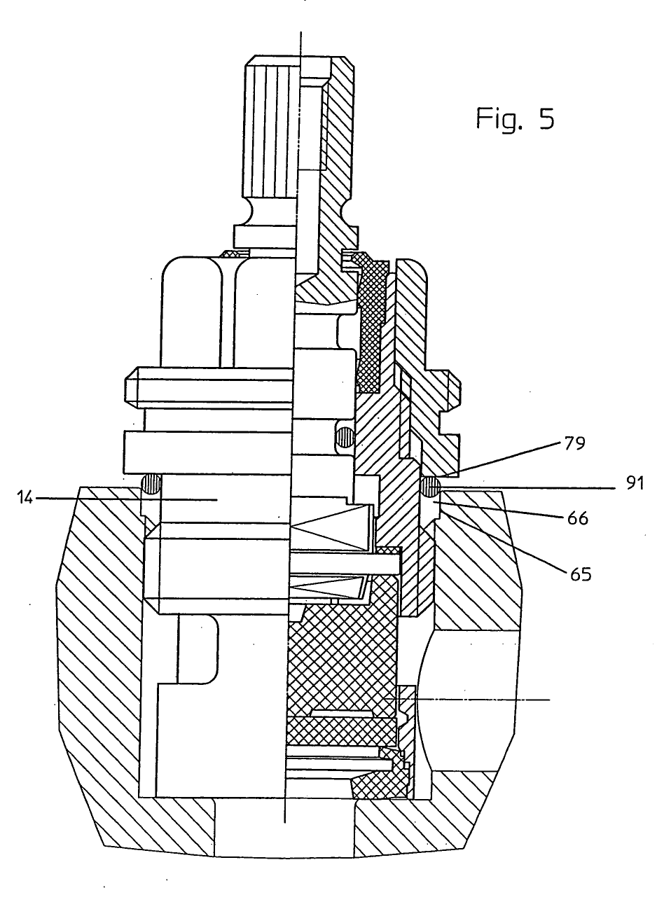

Before assembly of the upper valve part into the housing, O-ring 91 lies against sealing surface 14 of head piece 1, or is located in a position in which it can be pushed in, on the side of sealing surface 14 that faces away from the housing. When head piece 1 is screwed in, O-ring 91 then moves closer to O-ring sealing surface 65 provided on housing 6. By screwing on cap 7, the screw-in collar 76 comes into contact with O-ring 91, with its ring surface 79, in case O-ring 91 has not moved all the way to O-ring sealing surface 65 (FIG. 5), and presses the ring all the way to O-ring sealing surface 65, without damaging it, as the cap is screwed on further, until ring surface 79 lies on housing 6 (FIG. 1). Because of the contour of O-ring sealing surface 65, sealing surface 14, as well as ring surface 79, an O-ring installation space 66 is created, in which O-ring 91 comes to rest without being damaged, thereby creating the seal.

In addition, using the upper valve part, the handle of the fitting can be precisely aligned in its position. This is achieved in that head piece 1 and cap 7 are connected with one another by means of outside thread 15 and inside thread 73, so that they can be screwed into one another. First, head piece 1 is screwed into the housing, until seal ring 5 comes into contact with valve seat 61. This takes place by means of setting the handle onto spindle 2 and turning the handle, thereby bringing about precise positioning of the handle relative to the housing, because of the positive-lock connection between handle and spindle 2, as well as the limited ability of spindle 2 to rotate in head piece 1. It is true that the handle can be taken off after head piece 1 has been screwed in using the handle and spindle 2, and set on again, in an offset position, for alignment; but because of the raster of outer polygon 21, which is not step-free, precise alignment is not possible. For this purpose, the head piece would have to be screwed in further than until the screw-in collar makes contact with the housing, which leads to great mechanical stresses in the thread, i.e. in the region of the sealing surface for the O-ring, and can have a negative effect on the permanent strength of the upper valve part. With the upper valve part according to the invention, however, there is the possibility of allowing precise positioning of the handle. In this connection, the handle is held and the position of head piece 1 in housing 6 is wedged by screwing cap 7 in the direction of housing 6. In the exemplary embodiment, thread combination 15, 73 between head piece 1 and cap 7 has a lesser pitch than thread combination 13, 64 between head piece 1 and housing 6. This facilitates holding head piece 1 with the handle in the precise positioning. In this way, even more precise alignment of the handle is possible, something that can be desirable for design technology reasons, for example when assembling fittings disposed next to one another.

Accordingly, while only a few embodiments of the present invention have been shown and described, it is obvious that many changes and modifications may be made thereunto without departing from the spirit and scope of the invention.

What is claimed is:

1. An upper valve part comprising:
a housing;
a head piece connected to the housing via a connection thread on the head piece;
a spindle passing through a center of the head piece;
a spindle valve activated by the spindle, said valve resting against a valve seat of the housing;
wherein the head piece has a sealing surface in a direction of a side facing away from the housing, adjacent the connection thread, said surface forming a part of an O-ring installation space when a cap is screwed onto the head piece.

2. An upper valve part according to claim 1, further comprising a cap screwed onto the head piece, wherein the O-ring installation space is formed by an O-ring sealing surface of the housing, the sealing surface of the head piece and a ring surface of the cap.

3. An upper valve part according to claim 2, wherein the cap is screwed onto the head piece via a thread combination, and wherein the thread combination between the head piece and the cap has a lesser pitch than that of a thread combination formed from the connection thread of the head piece and a connection thread of the housing.

4. An upper valve part according to claim 1, further comprising a stuffing box surrounding the spindle and being positioned in a recess in the head piece.
